(19) United States
(12) Patent Application Publication
(10) Pub. No.: US 2022/0332163 A1
(43) Pub. Date: Oct. 20, 2022

(54) SYSTEM FOR INTEGRATED CONTROL OF THE TEMPERATURE OF A BATTERY AND OF AN INTERIOR AIR CONDITIONING APPARATUS IN A VEHICLE

(71) Applicant: DENSO THERMAL SYSTEMS S.P.A., Poirino (TO) (IT)

(72) Inventors: Stefano CAGLIERO, Poirino (TO) (IT); Pasquale NAPOLI, Poirino (TO) (IT)

(21) Appl. No.: 17/639,833

(22) PCT Filed: Sep. 1, 2020
(86) PCT No.: PCT/IB2020/058119

§ 371 Date: Mar. 2, 2022

(30) Foreign Application Priority Data
Sep. 2, 2019 (IT) 102019000015374

(51) Int. Cl. B60H 1/00; B60H 1/32; H01M 10/613; H01M 10/615; H01M 10/625; H01M 10/663; H01M 10/63; H01M 10/6568; H01M 10/6556

(52) U.S. Cl. CPC B60H 1/00278; B60H 1/00885; B60H 1/32284; H01M 10/613; H01M 10/615; H01M 10/625; H01M 10/663; H01M 10/63; H01M 10/6568; H01M 10/6556; B60H 2001/00307; H01M 2220/20; B60L 2240/545; B60L 58/26

(57) ABSTRACT

A system has a battery and an air conditioner in a thermal exchange relationship with an interior of a vehicle. A thermal regulation circuit has liquid pass through. The circuit includes an operative tract in a thermal exchange relationship with the battery to control battery temperature. An interior heating tract connects in parallel with the operative tract and in a thermal exchange relationship with the air conditioner. A refrigeration circuit is configured to have fluid pass through that is subjected to a non-reversible refrigeration cycle. The refrigeration circuit includes a condenser and an evaporator, which are in a thermal exchange relationship with a heating tract and a cooling tract of the thermal regulation circuit. The conditioner includes heating and cooling modules in a thermal exchange relationship with the thermal regulation circuit at respectively, the interior heating tract, and the refrigeration circuit at a spill duct connected parallel with the evaporator.

### TECHNICAL FIELD

The present invention relates to a system for integrated control of the temperature of a battery and of an interior air conditioning apparatus in a vehicle.

### BACKGROUND ART

It is generally known that vehicles are equipped with batteries supplying electric power to devices and apparatuses installed in such vehicles. In particular, in some modern applications power is also supplied in order to at least partly propel the vehicle, e.g. on electric or “hybrid” vehicles.

In order to be able to use the battery cooling system for cooling the interior as well, a water chiller is typically employed, mounted in parallel with the battery. This however causes a problem as concerns water temperature control, in that the temperature of the water used for conditioning the interior must be lower than that of the water delivered to the batteries. In addition, with a single water exchanger it is not possible to provide an effective defogging function for defogging the windshield of the vehicle.

### SUMMARY OF THE INVENTION

It is one object of the present invention to provide a system for integrated control of the temperature of a battery and of an interior air conditioning apparatus in a vehicle, wherein such system can solve the problems suffered by the prior art and can be manufactured in a simple and economical manner.

According to the present invention, this and other objects are achieved through a system having the technical features set out in the appended independent claim.

In particular, the use of a conditioning apparatus including a first heating module in thermal exchange relation with a thermal regulation circuit at an interior heating tract and of a second cooling module in thermal exchange relation with a refrigeration circuit at a spill duct connected in parallel with the evaporator makes it possible to achieve effective integrated control over the temperature of the battery and of the interior air conditioning apparatus of the vehicle.

It is understood that the appended claims are an integral part of the technical teachings provided in the following detailed description of the present invention. In particular, the appended dependent claims define some preferred embodiments of the present invention that include some optional technical features.

Further features and advantages of the present invention will become apparent in light of the following detailed description, provided merely as a non-limiting example and referring, in particular, to the annexed drawings as summarized below.

### BRIEF DESCRIPTION OF THE DRAWINGS

FIG. 1 is a functional block diagram representing a system for integrated control of the temperature of a battery and of an interior air conditioning apparatus in a vehicle made in accordance with an exemplary embodiment of the present invention.

FIGS. 2 and 3 are block diagrams similar to the one shown in FIG. 1, wherein such system is depicted in a heating configuration and, respectively, in a cooling configuration.

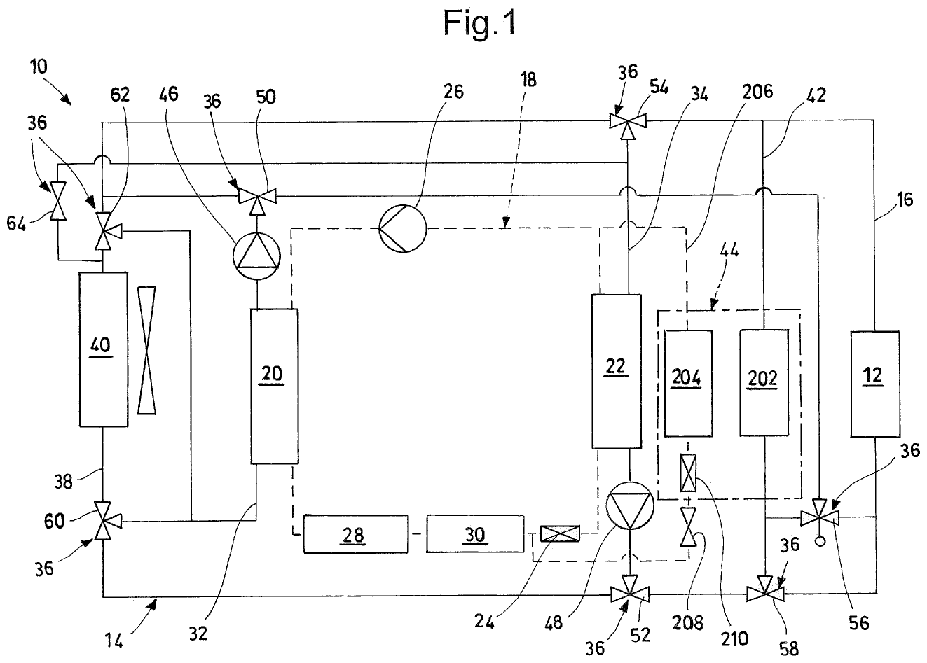

### DETAILED DESCRIPTION OF THE INVENTION

With reference to the annexed drawings, reference numeral 10 designates as a whole a system for integrated control of the temperature of a battery and of an interior air conditioning apparatus in a vehicle.

As will be apparent to a person skilled in the art, system 10 may be configured for use in a motor vehicle of any category and type. For example, said motor vehicle may be a motorcar for transporting people or goods, a commercial vehicle, an industrial vehicle, a military vehicle, a building-site vehicle, a sports car, a sport utility vehicle (SUV), an agricultural machine, a train, a bus, etc. Such vehicle may be propelled by means of an internal combustion engine, an electric motor or a “hybrid” propulsion system.

System 10 comprises a battery 12 (or a plurality of batteries) configured for outputting electric power, the temperature of which needs to be controlled, in particular increased or decreased, according to the operating conditions.

As will be apparent to a person skilled in the art, battery 12 may be any type of battery wherein it is necessary, or desirable, to control the temperature. In particular, battery 12 is configured for supplying electric power to the vehicle on which system 10 is installed. For example, the electric power that the battery can supply may be at least partly used for propelling the vehicle on which the system is installed.

System 10 further comprises a thermal regulation circuit 14, shown in the drawings by means of a continuous line. Thermal regulation circuit 14 is configured for being run through by any liquid, e.g. water, suitable for thermally interacting with battery 12, in particular for heating or, respectively, cooling it depending on the operating condition of system 10.

As will be described more in detail below, thermal regulation circuit 14 comprises a plurality of ducts or branches configured to be put in selective communication with one another, so as to define a plurality of paths for the liquid flowing there through.

Thermal regulation circuit 14 comprises an operative tract 16 in thermal exchange relation with battery 12, so as to control the temperature thereof. In this manner, the liquid flowing through operative tract 16 can thermally interact with battery 12. In particular, the liquid flowing through operative tract 16 can yield heat to battery 12 and, respectively, receive heat from battery 12, depending on the temperature of the liquid compared with that of th battery 12.

System 10 further comprises a refrigeration circuit 18, shown in the drawings by means of a dashed line. Refrigeration circuit 18 is configured for being run through by a fluid that can be subjected to a refrigeration cycle in a non-reversible manner and co-operates with thermal regulation circuit 14, as will be described more in detail below.

Refrigeration circuit 18 comprises a condenser 20 and an evaporator 22. In the embodiment illustrated herein by way of example, refrigeration circuit 18 comprises an expansion or lamination valve 24 connected downstream of condenser 20 and upstream of evaporator 22, and a compressor connected downstream of evaporator 22 and upstream of condenser 20.

Preferably, refrigeration circuit 18 further comprises an accumulator 28 connected downstream of the condenser and upstream of expansion or lamination valve 24. In addition, in the exemplary embodiment illustrated herein the refrigeration circuit comprises a dryer 30 connected downstream of condenser 20 (in particular, in a position situated downstream of accumulator 28) and upstream of expansion or lamination valve 24.

Condenser 20 is in thermal exchange relation with a heating tract 32 of thermal regulation circuit 14, whereas evaporator 22 is in thermal exchange relation with a cooling tract 34 of thermal regulation circuit 14.

Conditioning apparatus 44 comprises a first heating module 202 and a second cooling module 204. Heating module 202 is in thermal exchange relation with thermal regulation circuit 14 at interior heating tract 42. The second cooling module 204 is in thermal exchange relation with refrigeration circuit 18 at a spill duct 206 connected in parallel with evaporator 22. Such characteristics permit an advantageous integration for controlling the temperature of the battery and of the interior air conditioning apparatus of the vehicle.

In particular, the first heating module 202 and the second cooling module 204 co-operate together aeraulically—more specifically, in series—to effect the thermal exchange with the interior or cabin. By way of example, and as will be clarified below, the first heating module 202 may be at least partly capable of supplying heat to the windshield of the vehicle on which system 10 is to be installed.

In the embodiment illustrated herein, system 10 comprises a valve assembly 36 associated with thermal regulation circuit 14. Valve assembly 36 is configured to act upon thermal regulation circuit 14 by selectively taking a heating configuration and a cooling configuration, in particular with reference to the thermal exchange occurring with battery 12. For example, the operation of valve assembly 36—and, in particular, the switching between the heating configuration and the cooling configuration can be controlled by a control device or module (not shown) included in system 10 in accordance with predetermined or operator-defined criteria.

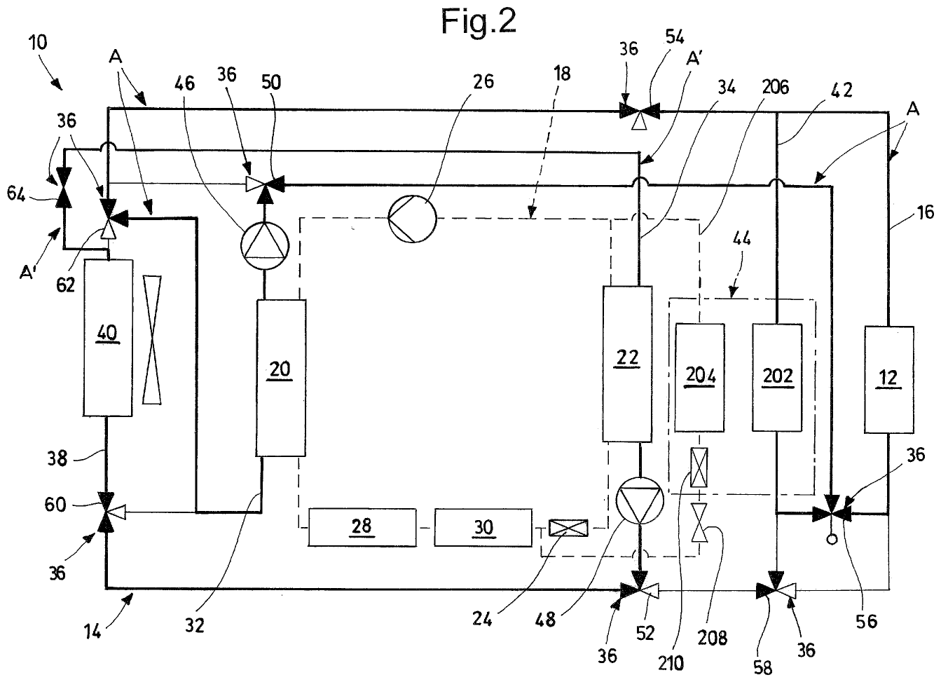

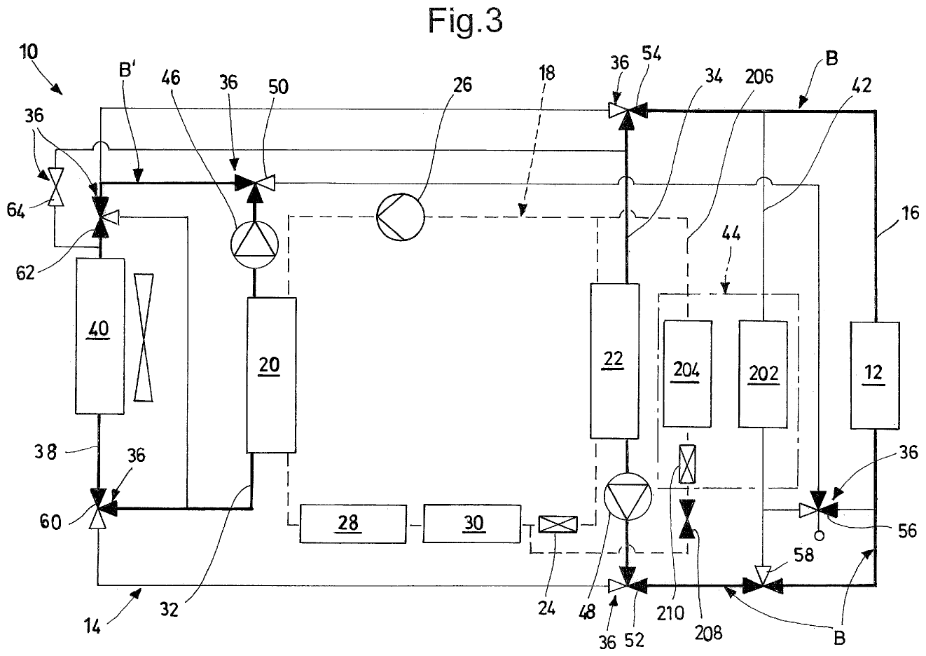

By way of non-limiting example, in FIG. 2 system 10 is shown with valve assembly 36 in the heating configuration, whereas in FIG. 3 system 10 is shown with valve assembly 36 in the cooling configuration.

Preferably, system 10 further comprises a spill valve device 208 configured for taking an operative condition and, respectively, an inoperative condition. In the operative condition, spill valve device 208 allows the flow of at least a part of said fluid coming from refrigeration circuit 18. In the inoperative condition, on the contrary, spill valve device 208 prevents the flow of said fluid coming from refrigeration circuit 18 through spill duct 206. In the following description other possible modes of operation of spill valve device 208 in the possible configurations of valve assembly 36 will also be described.

In the embodiment illustrated herein, spill valve device 208 is connected downstream of condenser 20 and upstream of evaporator 22.

In the embodiment illustrated herein, spill valve device 208 is connected upstream of an expansion or lamination valve 24 of refrigeration circuit 18. Particularly, spill valve device 208 is connected downstream of an accumulator 28 of refrigeration circuit 18. Even more particularly, spill valve device 208 is connected downstream of a dryer 30 of refrigeration circuit 18.

As will be apparent to a person skilled in the art, several different options are available as regards the realization of spill valve device 208. According to one possible example, spill valve device 208 may include a shut-off valve configured for preventing and, respectively, allowing the flow of fluid into spill duct 206 from refrigeration circuit 18; in such a case, spill device 208 will act upon the fluid flow through the respective spill duct 206 in a selective manner. According to a further possible example, spill valve device 208 may include a flow control valve; in such a case, spill device 208 will act upon the flow of fluid through the respective spill duct 206 in a proportional manner, permitting an adjustable intake of a quantity of fluid from refrigeration circuit 18 depending on the simultaneous needs in terms of refrigeration of the interior or cabin of the vehicle and cooling of battery 12.

Preferably, air conditioning apparatus 44 further comprises an auxiliary expansion or lamination valve 210 situated in spill duct 206. In the illustrated embodiment, auxiliary expansion or lamination valve 210 is situated downstream of spill valve device 208 and upstream of the second cooling module 204.

In FIG. 2, system 10 is shown with valve assembly 36 in the heating configuration. In the heating configuration, valve assembly 36 defines in thermal regulation circuit 14 a closed heating path for the liquid between operative tract 16 and heating tract 32. The closed heating path, indicated by black arrows designated as A in FIG. 2, is represented with a bolder line in comparison with the rest of thermal regulation circuit 14.

In FIG. 3, system 10 is shown with valve assembly 36 in the cooling configuration. In the cooling configuration, valve assembly 36 defines in thermal regulation circuit 14 a closed cooling path for the liquid between operative tract 16 and cooling tract 34. The closed cooling path, indicated by black arrows designated as B in FIG. 3, is shown with a bolder line in comparison with the rest of thermal regulation circuit 14.

Typically, the heating configuration is used in the vehicle in the winter period, or anyway at lower operating temperatures. On the contrary, the cooling configuration is used in the vehicle in the summer period, or anyway at higher operating temperatures.

Preferably, thermal regulation circuit 14 comprises a thermal stabilization tract 38 in thermal exchange relation with a radiator 40. For example, radiator 40 may be the radiator of the vehicle on which system 10 is intended to be installed.

In particular, in the heating configuration shown in FIG. 2 valve assembly 36 defines in thermal regulation circuit 14 a further closed cooling path, drawn with a bolder line and designated as A′, for the liquid. The further closed cooling path A′ is defined by connecting together cooling tract 34 and thermal stabilization tract 38. In the embodiment illustrated herein, in such heating configuration valve assembly 36 simultaneously defines the closed heating path A associated with battery 12 and the further closed cooling path A′ associated with radiator 40, such closed paths A and A′ being separate from each other.

In particular, in the cooling configuration shown in FIG. 3 valve assembly 36 defines in thermal regulation circuit 14 a further closed heating path, drawn with a bolder line and designated as B′, for the liquid. The further closed heating path B′ is defined by connecting together heating tract 32 and thermal stabilization tract 38. In the embodiment illustrated herein, in such cooling configuration valve assembly 36 simultaneously defines closed cooling path B associated with battery 12 and the further closed heating path B′ associated with radiator 40, such closed paths B and B′ being separate from each other.

In the embodiment illustrated herein, in the heating configuration (FIG. 2) spill valve device 208 is configured for taking the inoperative condition. In this way, no fluid is taken in from refrigeration circuit 18, in particular also because during the winter period it is not generally necessary to cool the interior of the vehicle. Therefore, the second cooling module 204 is not activated to cool the interior, but the first heating module 202 is activated in order to heat the interior.

In the illustrated embodiment, in the cooling configuration (FIG. 3) spill valve device 208 is configured for taking the operative condition. Fluid is thus taken in from refrigeration circuit 18, in particular also because during the summer period it is generally necessary to cool the interior of the vehicle. At the same time, the second cooling module 204 is activated, but the first heating module 202 is not generally activated. However, as will be clarified below, should it be necessary to defog the windshield of the vehicle, it will be possible to selectively activate —typically for short time periods—also the first heating module 202 by appropriately controlling valve assembly 36; in such a case, the first heating module 202 and the second cooling module 204 will be operating simultaneously.

In the embodiment illustrated herein, interior heating tract 42 is configured to be connected in parallel with operative tract 16, in particular when valve assembly 36 is in the heating configuration shown in FIG. 2.

In the embodiment illustrated herein, system 10 further comprises a heating pumping device 46 configured to induce a forced circulation of liquid in the closed heating path when valve assembly 36 is in the heating configuration. In particular, heating pumping device 46 is situated in heating tract 32.

In the embodiment illustrated herein, system 10 further comprises a cooling pumping device 48 configured to induce a forced circulation of liquid in the closed cooling path when valve assembly 36 is in the cooling configuration. In particular, cooling pumping device 48 is situated in cooling tract 34.

Preferably, valve assembly 36 comprises a heating valve 50, a cooling valve 52 and a return switching valve 54. Heating valve 50 is situated between heating tract 32 and operative tract 16. Cooling valve 52 is situated between cooling tract 34 and operative tract 16. Return switching valve 54 is situated downstream of operative tract 16 and upstream of heating tract 32 and of cooling tract 34.

In the embodiment illustrated herein, heating valve 50 is also a switching valve and is situated downstream of heating tract 32 and upstream of operative tract 16 and of thermal stabilization tract 38.

In the embodiment illustrated herein, cooling valve 52 is also a switching valve and is situated downstream of cooling tract 34 and upstream of operative tract 16 and of thermal stabilization tract 38.

In particular, in the heating configuration of valve assembly 36 shown in FIG. 2:

heating valve 50 allows the flow of liquid between heating tract 32 and operative tract 16, while preferably preventing the flow of liquid between heating tract 32 and thermal stabilization tract 38;

cooling valve 52 prevents the flow of liquid between cooling tract 34 and operative tract 16, while preferably allowing the flow of liquid between cooling tract 34 and thermal stabilization tract 38; and

return switching valve 54 selectively allows the flow of liquid between operative tract 16 and heating tract 32, thus bypassing cooling tract 34.

In particular, in the cooling configuration of valve assembly 36 shown in FIG. 3:

heating valve 50 prevents the flow of liquid between heating tract 32 and operative tract 16, while preferably allowing the flow of liquid between heating tract 32 and thermal stabilization tract 38;

cooling valve 52 allows the flow of liquid between cooling tract 34 and operative tract 16, while preferably preventing the flow of liquid between cooling tract 34 and thermal stabilization tract 38;

return switching valve 54 selectively allows the flow of liquid between operative tract 16 and cooling tract 34, thus bypassing heating tract 32.

In the embodiment illustrated herein, valve assembly 36 further comprises an intermediate valve arrangement configured for controlling the flow towards interior heating tract 42 and operative tract 16 in the heating configuration and, respectively, in the cooling configuration.

In particular, the intermediate valve arrangement comprises a first intermediate valve 56 situated downstream of heating tract 32 and of heating valve 50. Also, the first intermediate valve 56 is situated upstream of interior heating tract 42 and of operative tract 16, which are connected in parallel with each other. The first intermediate valve 56 is configured for controlling, in the heating configuration, the flow of fluid coming from heating tract and directed towards interior heating tract 42 and operative tract 16. Preferably, the first intermediate valve is a flow control valve (e.g. a proportional valve) configured for distributing, in the heating configuration, the flow of liquid between interior heating tract 42 and operative tract 16 (e.g. only allowing the flow of liquid into either one of interior heating tract 42 and operative tract 16 and, respectively, distributing a part of the flow to interior heating tract 42 and the other part of the flow to operative tract 16). Conversely, in the cooling configuration the first intermediate valve 56 inhibits the flow of liquid coming from the heating tract 32 towards the interior heating tract 42.

In particular, the intermediate valve arrangement comprises a second intermediate valve 58 situated downstream of cooling tract 34 and of cooling valve 52. Also, the second intermediate valve 58 is connected between interior heating tract 42 and operative tract 16, which are connected in parallel with each other. The second intermediate valve 58 is configured for controlling, in the cooling configuration, the flow of fluid coming from cooling tract 34 and directed towards interior heating tract 42 and operative tract 16. Preferably, in the cooling configuration the second intermediate valve 58 is a switching valve that selectively puts in communication cooling tract 34 and operative tract 16, preventing the flow of liquid through interior heating tract 42. Conversely, in the heating configuration, downstream of cooling valve 52, the second intermediate valve selectively prevents the communication between cooling tract 34 and operative tract 16.

As aforementioned, in the cooling configuration it may be necessary to defog the windshield of the vehicle by activating—at least temporarily—the first heating module 202. In the illustrated embodiment, such activation is effected by acting upon valve assembly 36, and in particular upon the intermediate valve arrangement, e.g. upon the second intermediate valve 58. In this case, the second intermediate valve 58 may be configured for taking a normal condition (shown in FIG. 3) and, respectively, a defogging condition (not shown in the drawings). The normal condition prevents the flow of liquid through the interior heating tract and, respectively, the defogging condition (not shown in the drawings) allows the flow of liquid through interior heating tract 42 in parallel with operative tract 16 in closed cooling path B. In the defogging condition the first heating module 202 is therefore active. The liquid, although cooled in order to be able to reduce the temperature of battery 12, will have a higher temperature than the fluid acting upon the second heating module 204, and may contribute to heating, —thereby effectively defogging it—the windshield of the vehicle.

In the embodiment illustrated herein, the valve assembly 36 further comprises a pair of recirculation valves 60, 62, e.g. a pair of switching valves, and a bypass valve 64, e.g. a shut-off valve, configured for connecting the thermal stabilization tract 38 to the heating tract 32 and, respectively, to the cooling tract 34.

In the embodiment illustrated herein, the valve assembly 36 further comprises a pair of recirculation valves 60, 62, e.g. a pair of switching valves, and a bypass valve 64, e.g. a shut-off valve, configured for connecting the thermal stabilization tract 38 to the heating tract 32 and, respectively, to the cooling tract 34.

In the heating configuration the following occurs:

the first recirculation valve 60 sequentially puts in mutual liquid communication cooling tract 34 (downstream of the cooling valve 52) and thermal stabilization tract 38,

the second recirculation valve 62 sequentially puts in mutual liquid communication the output tract of return valve 54 and heating tract 32, and

bypass valve 64 sequentially puts in mutual liquid communication thermal stabilization tract 38 (upstream of recirculation valve 62) and cooling tract 34.

In the cooling configuration the following occurs:

the first recirculation valve 60 sequentially puts in mutual liquid communication thermal stabilization tract 38 and heating tract 32,

the second recirculation valve 62 sequentially puts in mutual liquid communication heating tract 32 (downstream of heating valve 50) and thermal stabilization tract 38,

bypass valve 64 prevents the liquid communication between thermal stabilization tract 38 (downstream of recirculation valve 62) and cooling tract 34.

Of course, without prejudice to the principle of the invention, the forms of embodiment and the implementation details may be extensively varied from those described and illustrated herein by way of non-limiting example, without however departing from the scope of the invention as set out in the appended claims.

1. A system for integrated control of a temperature of at least one battery and an interior air conditioning apparatus of a vehicle; said system comprising:
at least one battery configured for outputting electric power;
an air conditioning apparatus in thermal exchange relation with an interior or cabin of the vehicle;
a thermal regulation circuit configured for having liquid pass through and comprising:
an operative tract in thermal exchange relation with said battery, to control the temperature of the battery, and
an interior heating tract connected in parallel with said operative tract and in thermal exchange relation with said air conditioning apparatus;
a refrigeration circuit configured for having fluid pass through that is subjectable to a refrigeration cycle in a non-reversible manner; said refrigeration circuit in turn comprising a condenser and an evaporator, which are in thermal exchange relation with a heating tract and, a cooling tract of said thermal regulation circuit for heating and, cooling said liquid passing through said operative tract; and
said conditioning apparatus comprising:
a first heating module in thermal exchange relation with said thermal regulation circuit at said interior heating tract; and
a second cooling module in thermal exchange relation with said refrigeration circuit at a spill duct connected in parallel with said evaporator.

2. The system according to claim 1, further comprising a spill valve device configured for taking an operative condition in which said spill valve device allows the flow of at least a part of said fluid and, an inoperative condition which prevents the flow of said fluid from said refrigeration circuit through said spill duct.

3. The system according to claim 2, wherein said spill valve device is connected downstream of said condenser and upstream of said evaporator.

4. The system according to claim 2, wherein said spill valve device is connected upstream of an expansion or lamination valve of said refrigeration circuit.

5. The system according to claim 4, wherein said spill valve device is connected downstream of an accumulator of said refrigeration circuit.

6. The system according to claim 5, wherein said spill valve device connected downstream of a dryer of said refrigeration circuit.

7. The system according to claim 2, wherein said spill valve device is a shut-off valve configured for preventing and, respectively, allowing the flow of fluid into the spill duct from the refrigeration circuit.

8. The system according to claim 2, wherein said spill valve device is a flow control valve.

9. The system according to claim 2, wherein said air conditioning apparatus further comprises an auxiliary expansion or lamination valve situated in the spill duct.

10. The system according to claim 9, wherein said auxiliary expansion or lamination valve is situated downstream of the spill valve device and upstream of the second cooling module.

11. The system according to claim 2, further comprising a valve assembly associated with the thermal regulation circuit and configured for selectively taking:
a heating configuration, in which said valve assembly defines, in the thermal regulation circuit, a closed heating path for the liquid between the operative tract and the heating tract;
a cooling configuration, in which said valve assembly defines, in the thermal regulation circuit, a closed cooling path for the liquid between the operative tract and the cooling tract.

12. The system according to claim 11, wherein in said heating configuration said spill valve device is in said inoperative condition, and wherein in said cooling configuration said spill valve device is in said operative condition.

13. The system according to claim 12, wherein said valve assembly comprises an intermediate valve arrangement configured for taking a normal condition and a defogging condition, wherein, in said cooling configuration, said intermediate valve arrangement prevents and, respectively, allows the flow of liquid through said interior heating tract in parallel with said operative tract.

14. The system according to claim 1, wherein said modules are connected to and aeraulically co-operate with each other in series to accomplish the thermal exchange with said interior or cabin.
